(19) United States
(12) Patent Application Publication
(10) Pub. No.: US 2009/0217374 A1
(43) Pub. Date: Aug. 27, 2009

(54) License Scheme for Enabling Advanced Features for Information Handling Systems

(76) Inventors: Wei Liu, Austin, TX (US); Jianwen Yin, Round Rock, TX (US); Lei Wang, Austin, TX (US)

Correspondence Address: HAMILTON & TERRILE, LLP, P.O. BOX 203518, AUSTIN, TX, 78720, US

(21) Appl. No.: 12/037,903

(22) Filed: Feb. 26, 2008

(51) Int. Cl. H04L 9/32

(52) U.S. Cl. 726/19

(57) ABSTRACT

A method for BIOS to pass license key information to a device via CLP interface during a power on self-test (POST). The license key may be stored in different locations within the information handling system. For example, the license key may be stored within a secure location on a BIOS flash chip, in which case the license key is maintained across BIOS updates. Alternately, the license key may be stored within motherboard persistent storage (such as an internal universal serial bus (USB) key that is provided on certain servers. Alternately, the license key may be stored on a central location on a network to which the information handling system is coupled.

### BACKGROUND OF THE INVENTION

1. Field of the Invention

The present invention relates to information handling systems and more particularly to enabling advanced features for information handling systems.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

It is known to provide an information handling system with a basic input output system (BIOS). It is also known to provide an information handling system with a peripheral component interconnect (PCI) type input/output (I/O) bus. PCI type buses conform to a PCI specification that is defined by the PCI special interest group (PCI-SIG) specification. The PCI specification also includes a firmware (FW) specification for enabling interaction of firmware with devices coupled to the information handling system via the PCI type bus.

For example, the PCI FW3.0 specification defines a Command Line Protocol (CLP) interface that enables a system BIOS to pass information to PCI option ROMs. An entry point is provided by the Option ROM to support device configuration. The interface is accessed with a far call operation (i.e., a call to a routine that is loaded into a different segment of memory from the caller) where the system BIOS passes in a Distributed Management Task Force Systems Management (DMTF SM) CLP compatible configuration message (string) that targets the device or a child of that device.

It is known that certain next generation network interface controllers (NICs) support PCI FW 3.0 type Option read only memories (Option ROMs).

### SUMMARY OF THE INVENTION

In accordance with the present invention, a method is set forth for BIOS to pass license key information to a device via CLP interface during a power on self-test (POST). The license key may be stored in different locations within the information handling system. For example, the license key may be stored within a secure location on a BIOS flash chip, in which case the license key is maintained across BIOS updates. Alternately, the license key may be stored within motherboard persistent storage (such as an internal universal serial bus (USB) key that is provided on certain servers. Alternately, the license key may be stored on a central location on a network to which the information handling system is coupled.

More specifically, in one embodiment, the invention relates to a method for passing license key information to a device within an information handling system. The method includes providing a command line protocol (CLP) interface; passing license key information to the device via the CLP interface during a power on self test (POST) operation; authenticating the license key within the device; and, enabling one or more features of the device based upon the authenticating.

In another embodiment, the invention relates to an information handling system comprising a processor and memory coupled to the processor. The memory stores a license key system for passing license key information to a device within an information handling system. The license key system comprising instructions executable by the processor for: providing a command line protocol (CLP) interface; passing license key information to the device via the CLP interface during a power on self test (POST) operation; authenticating the license key within the device; and, enabling one or more features of the device based upon the authenticating.

In another embodiment, the invention relates to an apparatus for passing license key information to a device within an information handling system. The apparatus includes means for providing a command line protocol (CLP) interface; means for passing license key information to the device via the CLP interface during a power on self-test (POST) operation; means for authenticating the license key within the device; and, and means for enabling one or more features of the device based upon the authenticating.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 shows a system block diagram of an information handling system.

FIG. 2 shows a flow chart of the operation of a license key system.

FIG. 3 shows a flow chart of the operation of a system for providing a license key system to an information handling system.

### DETAILED DESCRIPTION

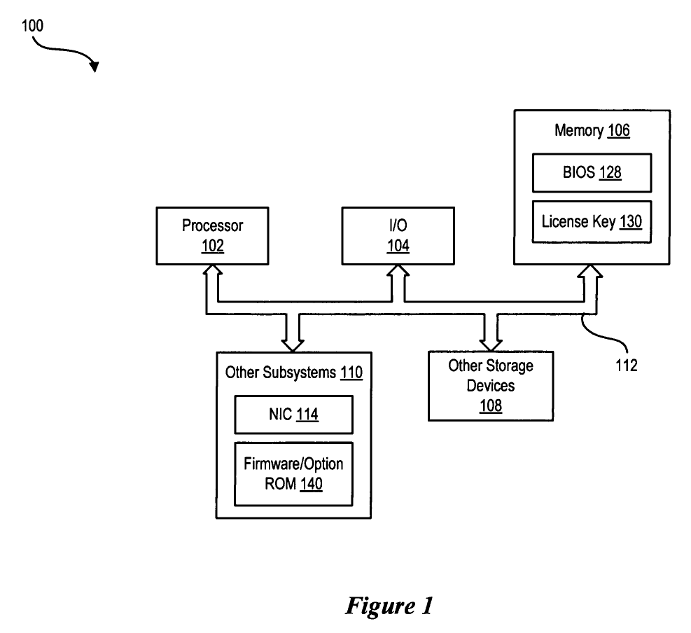

Referring briefly to FIG. 1, a system block diagram of an information handling system 100 is shown having features thereof configured in accordance with the on-line store 110 as discussed herein. The information handling system 100 includes a processor 102, input/output (I/O) devices 104, such as a display, a keyboard, a mouse, and associated controllers, memory 106, including volatile memory such as random access memory and non volatile memory such as a hard disk and drive or a flash memory, and other storage devices 108, such as an optical disk and drive and other memory devices, and various other subsystems 110, all interconnected via one or more buses 112, which may be a PCI type bus or buses. The other subsystems 110 may include, for example, a network interface controller (NIC) 114.

The memory 106 stores a BIOS 128 as well as a license key system 130. In operation, the BIOS 128 and the license key system 130 are executed by the processor 102.

The license key system 130 allows the information handling system 100 to enable certain advanced features of the NIC 114 such as a TCP offload engine (TOE), Internet Small Computer System Interface (iSCSI) offload, and remote direct memory access (RDMA). More specifically, the BIOS 128 reads a license key and passes the license to the NIC 114 via a PCI FW 3.0 CLP type interface during a power on self-test operation.

The NIC 114 includes firmware (FW) 140 (which in certain embodiments may be an Option ROM) which authenticates the license key and enables a certain advanced feature or a combination of features that are associated with the key. In case the key is stored in a central location on network, BIOS can obtain the key from a Baseboard Management Controller (BMC) via intelligent platform management interface (IPMI) type commands.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

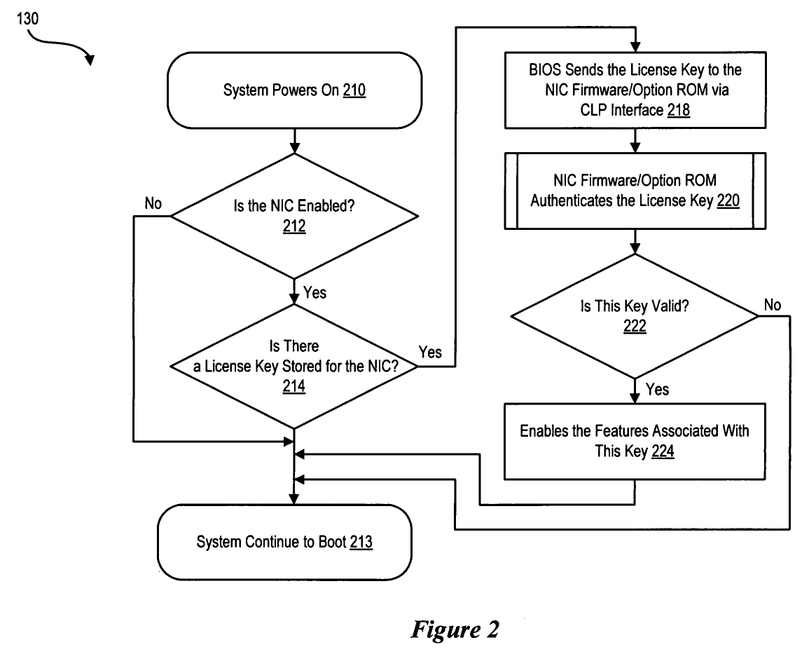

FIG. 2 shows a flow chart of the operation of a license key system 130. More specifically, when the information handling system 100 first powers on at step 210, the license key system 130 determines whether the NIC 114 is enabled at step 212. If the NIC 114 is not enabled, then the system continues to boot at step 213.

If the NIC 114 is enabled, then the license system 130 determines whether a license key is stored for the NIC 114 at step 214 (e.g., within BIOS memory, within motherboard persistent memory or storage coupled to the network). If the license key is not present, then the system continues to boot at step 213.

Next, the license key system 130 reads license key and passes the license key to a NIC firmware via a CLP interface. The NIC firmware 140 then authenticates the license key at step 220 and determines whether the key is valid at step 222. If the key is not valid, then the system continues to boot at step 213.

If the key is valid, as determined at step 222, then the firmware 140 enables the advanced feature or features that are qualified by the license key at step 224 and the system continues to boot at step 213.

In certain embodiments, the key can be pre-installed in the factory. Therefore, the system can be shipped out of the factory with the advanced feature enabled. However, in other embodiments, the key may be provided to an information handling system aftermarket.

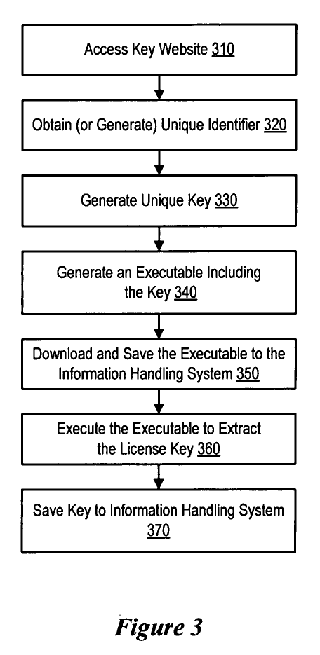

For example, referring to FIG. 3, a flow chart of the operation of a system for providing a license key system to an information handling system is shown. More specifically, the license key system 130 may include an application (e.g., a web application or utility) which enables aftermarket activation of one or more advanced features in case the customer did not initially order the feature (and thus a key which enables the feature was not preinstalled on the information handling system).

In operation, the license key system 130 enables a customer to navigate to a website to download a license key at step 3 10. The application obtains a unique identifier of the information handling system (such as a serial number or a Service Tag) of the information handling system) or generates a unique identifier (via e.g., an operation on a device ID/Vendor ID, serial number and media access control (MAC) address of the NIC 114) at step 320. Next, the application generates a unique key at step 330. The key is then included in an executable file at step 340. The customer then saves the executable which includes the key into a transportable memory such as a USB key type memory at step 350.

The customer then powers on a target information handling system and executes the license key system at step 360. The license key system 360 accesses and executes the executables that include the BIOS APIs that save the license key to the target information handling system at step 370.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

For example, the license key module can be extended to any enhanced hardware feature that requires a license key. The hardware is not necessarily limited to NICs; the hardware can include redundant array of independent disk (RAID) controllers, host bus adapter (HBA) type card, as well as other devices. With this licensing mechanism, an information handling system manufacturer can ship systems that include an advanced feature from factory if customers ordered it. Additionally an information handling system manufacturer can also release the advanced feature support firmware and driver publicly on the web for any customer to download or upgrade. Only those customers who pay for the license will be able to enable the feature. Such a mechanism can allow an information handling system manufacturer to generate extra revenue which providing customers with a convenient licensing mechanism. Such a mechanism also allows an information handling system manufacturer to release driver out of a regular release cycle to meet competition pressure and special customer needs.

Also for example, for a local area network on motherboard (LOM) type system whose option ROM might be disabled in BIOS setup, the PCI FW3.0 CLP interface may be used without loading the option ROM itself.

Also, for example, the above-discussed embodiments include software modules that perform certain tasks. The software modules discussed herein may include script, batch, or other executable files. The software modules may be stored on a machine-readable or computer-readable storage medium such as a disk drive. Storage devices used for storing software modules in accordance with an embodiment of the invention may be magnetic floppy disks, hard disks, or optical discs such as CD-ROMs or CD-Rs, for example. A storage device used for storing firmware or hardware modules in accordance with an embodiment of the invention may also include a semiconductor-based memory, which may be permanently, removably, or remotely coupled to a microprocessor/memory system. Thus, the modules may be stored within a computer system memory to configure the computer system to perform the functions of the module. Other new and various types of computer-readable storage media may be used to store the modules discussed herein. Additionally, those skilled in the art will recognize that the separation of functionality into modules is for illustrative purposes. Alternative embodiments may merge the functionality of multiple modules into a single module or may impose an alternate decomposition of functionality of modules. For example, a software module for calling sub-modules may be decomposed so that each sub-module performs its function and passes control directly to another sub-module.

Consequently, the invention is intended to be limited only by the spirit and scope of the appended claims, giving full cognizance to equivalents in all respects.

What is claimed is:

1. A method for passing license key information to a device within an information handling system comprising
providing a command line protocol (CLP) interface;
passing license key information to the device via the CLP interface during a power on self-test (POST) operation;
authenticating the license key within the device; and,
enabling one or more features of the device based upon the authenticating.

2. The method of claim 1 wherein,
the command line protocol interface conforms to a peripheral component interconnect (PCI) type firmware specification.

3. The method of claim 1 wherein,
the license key is stored so as to be accessible by the information handling system.

4. The method of claim 1 wherein,
the license key is stored in within at least one of a secure location on a BIOS flash chip, motherboard persistent storage or a central location on a network to which the information handling system is coupled.

5. The method of claim 1 wherein,
the device comprises a network interface controller; and,
the features comprise advanced features of the network interface controller.

6. The method of claim 1 wherein,
the advanced features of the network interface controller comprise at least one of a TCP offload engine (TOE), initiator type SCSI (iSCSI) offload, and remote direct memory access (RDMA).

7. An information handling system comprising:
a processor;
memory coupled to the processor, the memory storing a license key system for passing license key information to a device within an information handling system, the license key system comprising instructions executable by the processor for:
providing a command line protocol (CLP) interface;
passing license key information to the device via the CLP interface during a power on self-test (POST) operation;
authenticating the license key within the device; and,
enabling one or more features of the device based upon the authenticating.

8. The information handling system of claim 7 wherein,
the command line protocol interface conforms to a peripheral component interconnect (PCI) type firmware specification.

9. The information handling system of claim 7 wherein,
the license key is stored so as to be accessible by the information handling system.

10. The information handling system of claim 7 wherein,
the license key is stored in within at least one of a secure location on a BIOS flash chip, motherboard persistent storage or a central location on a network to which the information handling system is coupled.

11. The information handling system of claim 7 wherein,
the device comprises a network interface controller; and,
the features comprise advanced features of the network interface controller.

12. The information handling system of claim 7 wherein,
the advanced features of the network interface controller comprise at least one of a TCP offload engine (TOE), initiator type SCSI (iSCSI) offload, and remote direct memory access (RDMA).

13. An apparatus for passing license key information to a device within an information handling system comprising
means for providing a command line protocol (CLP) interface;
means for passing license key information to the device via the CLP interface during a power on self-test (POST) operation;
means for authenticating the license key within the device; and,
means for enabling one or more features of the device based upon the authenticating.

14. The apparatus of claim 13 wherein,
the command line protocol interface conforms to a peripheral component interconnect (PCI) type firmware specification.

15. The apparatus of claim 13 wherein,
the license key is stored so as to be accessible by the information handling system.

16. The apparatus of claim 13 wherein,
the license key is stored in within at least one of a secure location on a BIOS flash chip, motherboard persistent storage or a central location on a network to which the information handling system is coupled.

17. The apparatus of claim 13 wherein,
the device comprises a network interface controller; and,
the features comprise advanced features of the network interface controller.

18. The apparatus of claim 13 wherein,
the advanced features of the network interface controller comprise at least one of a TCP offload engine (TOE), initiator type SCSI (iSCSI) offload, and remote direct memory access (RDMA).
